(19) United States
(12) Patent Application Publication
(10) Pub. No.: US 2024/0075418 A1
(43) Pub. Date: Mar. 7, 2024

(54) FILTER SYSTEM COMPRISING A RESONATOR

(71) Applicant: MANN+HUMMEL GmbH, Ludwigsburg (DE)

(72) Inventors: Daniel SCHMID, Sachsenheim (DE); Kevin KOHN, Grossbottwar (DE); Sven EPLI, Heilbronn (DE)

(21) Appl. No.: 18/506,601

(22) Filed: Nov. 10, 2023

Related U.S. Application Data
(63) Continuation of application No. PCT/EP2022/061700, filed on May 2, 2022.

(30) Foreign Application Priority Data
May 10, 2021 (DE) 102021112125.6

(51) Int. Cl. B01D 46/42; B01D 46/24; F02M 35/02; F02M 35/024; F02M 35/12; F02M 35/14

(52) U.S. Cl. CPC B01D 46/4236; B01D 46/2414; F02M 35/0201; F02M 35/0216; F02M 35/02416; F02M 35/02483; F02M 35/1255; F02M 35/14; B01D 2265/028; B01D 2271/02

(57) ABSTRACT

A filter system for filtering a fluid has a filter housing with housing top part and housing bottom part, wherein the housing top and bottom parts extend along a housing axis. A filter pack arranged in the filter housing separates fluid-tightly a clean fluid side and a raw fluid side from each other. The filter pack has a filter element with a hollow cylinder-type filter bellows arranged about a longitudinal axis of the filter element. The filter element has a first substantially closed end face and a first end disk arranged thereat, wherein the first end disk is positioned opposite a second end disk of the filter element. The second end disk has a fluid passage for filtered fluid. A resonator with an end closed by a bottom is arranged inside the filter pack such that the bottom is oriented toward the first end disk of the filter element.

### CROSS-REFERENCE TO RELATED APPLICATIONS

This application is a continuation application of international application No. PCT/EP2022/061700 having an international filing date of May 2, 2022 and designating the United States, the international application claiming a priority date of May 10, 2021 based on prior filed German patent application No. 10 2021 112 125.6, the entire contents of the aforesaid international application and the aforesaid German patent application being incorporated herein by reference.

### BACKGROUND OF THE INVENTION

The invention concerns a filter system for filtering a fluid comprising a resonator, as well as a filter element and a secondary element for such a filter system, in particular of an air conducting system of an internal combustion engine, in particular of a motor vehicle.

US 2014/102304 A1 discloses an air filter arrangement for a motor which comprises a filter element, a sound attenuation element, and an end cap. The filter element is a cylindrical filter element defining a hollow interior. The sound attenuation element extends into the hollow interior of the cylindrical filter element. The sound attenuation element comprises a flange at a first end. The flange has a diameter which is larger than a diameter of the hollow interior. The end cap is fastened to the cylindrical filter element and serves to fix the sound attenuation element relative to the filter element. The sound attenuation element is effective to reduce motor noises traveling through the air filter arrangement.

### SUMMARY OF THE INVENTION

It is an object of the invention to provide a filter system for filtering a fluid comprising a resonator which enables an improved noise attenuation.

A further object is providing a filter element for such a filter system which enables an improved noise attenuation.

A further object is providing a secondary element for such a filter system which enables an improved noise attenuation.

The aforementioned object is solved according to an aspect of the invention by a filter system for filtering a fluid, at least comprising a filter housing with at least a housing top part and a housing bottom part which extend along a housing axis, a filter pack separating a clean fluid side and a raw fluid side and comprising at least one filter element, wherein the at least one filter element comprises a hollow cylinder-type filter bellows arranged about its longitudinal axis, wherein the filter element is embodied substantially closed at least at a first end face and comprises a first end disk which is positioned opposite a second end disk with a fluid passage for the filtered fluid, as well as a resonator with an end which is closed by a bottom, wherein the resonator is arranged in the interior of the filter pack so as to be oriented with its bottom toward the first end disk of the filter element.

The further object is solved by a filter element for use in a filter system, comprising a hollow cylinder-type filter bellows arranged about its longitudinal axis, wherein the filter element is embodied substantially closed at a first end face and the first end face comprises at least a first end disk which is positioned opposite a second end disk with a fluid passage for the filtered fluid.

The further object is solved by a secondary element for use in a filter system, comprising a hollow cylinder-type filter bellows arranged about its longitudinal axis, wherein the secondary element comprises an end disk at an end face.

Beneficial embodiments and advantages of the invention result from the additional claims, the description, and the drawing.

According to an aspect of the invention, a filter system for filtering a fluid is proposed, at least comprising a filter housing with at least a housing top part and a housing bottom part which extend along a housing axis, a filter pack separating fluid-tightly a clean fluid side and a raw fluid side and comprising at least one filter element, wherein the at least one filter element comprises a hollow cylinder-type filter bellows arranged about its longitudinal axis, and wherein the filter element at least at a first end face is embodied substantially closed and comprises a first end disk which is positioned opposite a second end disk with a fluid passage for the filtered fluid, as well as a resonator with an end closed by a bottom. In this context, the resonator is arranged in the interior of the filter pack so as to be oriented with its bottom toward the first end disk of the filter element.

Advantageously, the filter system, which is embodied for filtering a fluid, in particular of an air conducting system of an internal combustion engine, in particular of a motor vehicle, comprises a resonator for noise attenuation of the flowing fluid upon passing through the filter element of the filter system. The resonator as a part of the filter housing, fixedly connected to the latter, for example, welded, or exchangeably, for example, clipped on or screwed, can be arranged at the clean fluid side of the filter system.

For acoustic reasons, the resonator can be embodied advantageously as a tube open at one side and closed at the other side by a bottom. The resonator is arranged in the interior of the filter pack such that its bottom is oriented toward the first end disk of the filter pack. In particular, the resonator can be arranged expediently concentrically to the housing axis in order to affect an advantageous acoustic damping of the filter system.

The filter pack can comprise, for example, a filter element that is open at both sides along its longitudinal axis, wherein one side of the filter element seals in relation to the filter housing.

The hollow cylinder-type filter bellows comprises a closed circumferential wall which surrounds a longitudinal axis and can comprise an arbitrary cross section. The cross section of the filter bellows can be circular, rectangular, triangular, polygonal, oval or the like and can be adapted beneficially to an existing installation space. The filter bellows can comprise a folded filter medium or wound layers of filter medium. A combination of folded and wound filter media is possible also.

The second open side of the filter element can be sealed in an embodiment in relation to the resonator tube. The seal can be embodied in this context as a two-component (2K) seal, as polyurethane (PUR) seal, as O-ring or plastic/plastic seal, or as labyrinth seal. In this context, the seal can be arranged at the filter element, for example, at a central tube or at an end disk or at the resonator.

The filter pack can comprise furthermore a secondary element which is arranged as safety element in the interior of the filter element and which seals also in relation to the filter housing. The secondary element serves to prevent that raw fluid can flow to the clean fluid side and thus to the clean fluid outlet when exchanging the filter element. The secondary element, for example, can be embodied so as to be configured as so-called sock element which is sealed with a tight plastic cover at the end which is not sealed in relation to the filter housing. As an alternative, the secondary element can also be configured as screwed safety element which is open at the bottom and is then sealed by the resonator. In case of the sock element, a support structure of the secondary element for supporting the filter bellows can be part of the housing or, as a separate component, can be clipped on, welded or screwed.

The secondary element can be sealed by a seal device at the open end disk in relation to the resonator. The seal can be embodied, for example, as 2K seal, as PUR seal, as O-ring seal or as plastic/plastic seal or as labyrinth seal. The seal in this context can be arranged at the end disk of the secondary element or at the resonator.

Such a resonator can be accommodated in a filter system in an installation space-saving manner and can be produced inexpensively.

According to a beneficial embodiment of the filter system, the resonator and the filter pack can adjoin each other through a seal device. The resonator advantageously can be sealed in relation to the filter element or a secondary element, for example, at an open end disk. In this manner, the resonator can seal the filter element and/or the secondary element at the open end disk. The seal can be embodied in this context, for example, as 2K seal, as PUR seal, as O-ring seal or as plastic/plastic seal or as labyrinth seal. The seal in this context can be arranged at the end disk of the secondary element or of the filter element or at the resonator.

According to a beneficial embodiment of the filter system, the filter pack can comprise a central tube arranged in the interior of the filter bellows, wherein the bottom of the resonator is integrated in a bottom of the central tube of the filter pack. In this manner, the resonator can be manufactured inexpensively and fixed stably in the filter pack. Also, mounting of the resonator can be simplified in this way.

According to a beneficial embodiment of the filter system, an open end of the resonator positioned opposite the bottom can be fastened in the region of the second end disk. In this way, the resonator can be mounted in a beneficial manner at the filter element, for example, at the end disk or at a secondary element, and can also be easily removed, as needed, upon exchange of the filter element and mounted in another filter element. In this manner, the resonator that is subject to little wear, can be beneficially reused.

According to a beneficial embodiment of the filter system, the first end disk can have an opening through which the resonator partially extends, wherein the opening of the end disk seals relative to the resonator. The opening, in particular for a concentric arrangement of the resonator, can be formed centrally in the end disk. The resonator seals the filter element in this manner. When exchanging the filter element, the resonator can advantageously stay mounted in the filter housing and must not be exchanged together with the filter element.

The opening of the end disk can seal fluid-tightly relative to the resonator. A sealing action that is only acoustic can however be sufficient when the seal location is located at the clean side of the filter element, in particular of the main element.

According to a beneficial embodiment of the filter system, the first end disk can comprise a seal structure surrounding the opening as a seal device, in particular a PUR seal or an O-ring seal or a 2K seal or a labyrinth seal. In this way, the raw fluid side can be sealed advantageously in relation to the clean fluid side of the filter system. The seal structure can be arranged at the end disk because in this manner the resonator can be inexpensively produced. Alternatively, the seal structure can however be arranged also at the resonator.

According to a beneficial embodiment of the filter system, the resonator can be connected by a snap-on connection to the central tube. In this manner, the resonator can be inserted in a simple manner into the filter element and also removed when exchanging the filter element. In this way, the resonator can be beneficially reused because it is substantially not subject to any wear.

According to a beneficial embodiment of the filter system, the resonator can be connected to an end of the central tube which is positioned opposite the first end face of the filter element. In particular, the resonator can be connected by a snap-on connection. In particular, the resonator can be arranged so as to be exchangeable from the clean fluid side. In this way, the resonator can be mounted at the filter element in a beneficial manner and can also be easily removed when exchanging the filter element and mounted in another filter element. In this manner, the resonator which is subject to little wear can be beneficially reused.

According to a beneficial embodiment of the filter system, the resonator can be pushed in from the first end face of the filter element into the opening of the end disk. In particular, the resonator can be connected by a snap-on connection to the end disk. In this manner, the resonator can be easily mounted and, as needed, also removed again. A sealing action between resonator and end disk of the filter element can be arranged beneficially at the end disk. In this context, expediently a circumferentially extending PUR seal or an O-ring seal or a 2K seal or a labyrinth seal can be used as a seal device. In this way, a safe sealing action is advantageously possible even when exchanging the resonator because in this way the seal is also exchanged simultaneously for each exchange of the filter element.

According to a beneficial embodiment of the filter system, the filter pack can comprise furthermore a secondary element with a hollow cylinder-type filter bellows arranged about its longitudinal axis which is arranged inside the central tube of the filter element, in particular concentrically to the housing axis. In this context, the resonator can be arranged in the interior of the secondary element at least in sections, in particular concentric to the longitudinal axis, with the closed end oriented toward the first end disk of the filter element.

The filter pack can comprise a secondary element which is arranged as a safety element in the interior of the filter element and which seals also in relation to the filter housing. The secondary element serves to prevent that raw fluid can pass to the clean fluid side and thus to the clean fluid outlet when exchanging the filter element. The secondary element, for example, can be embodied so as to be configured as a so-called sock element which is sealed by a tight plastic cover at the end which is not sealed in relation to the filter housing. Alternatively, the secondary element can also be configured as a screwed safety element which is open at the bottom and is then sealed by the resonator. In case of the sock element, the central tube can be part of the housing or, as a separate component, can be clipped on, welded, glued or screwed.

According to a beneficial embodiment of the filter system, the secondary element can comprise an end disk with an opening through which the resonator extends partially, wherein the opening of the end disk seals tightly relative to the resonator. In this manner, the resonator can seal expediently the secondary element. In this way, the resonator, when exchanging the secondary element, can stay mounted at the filter housing and must not be also demounted and/or exchanged.

According to a beneficial embodiment of the filter system, the end disk can comprise a seal structure surrounding the opening, in particular a 2K seal or a PUR seal or an O-ring seal or a labyrinth seal. The secondary element can be sealed by a seal device at the open end disk in relation to the resonator. The seal in this context can be embodied, for example, as 2K seal, as PUR seal, as O-ring seal or as plastic/plastic seal or as labyrinth seal. The seal in this context can be arranged at the end disk of the secondary element or alternatively also at the resonator.

According to a beneficial embodiment of the filter system, the resonator can be connected to a support structure of the secondary element, in particular connected forming one piece therewith. In this manner, the resonator can be inexpensively produced and fixed stably in the secondary element. Mounting of the resonator can thus be simplified also because the resonator can be inserted together with the secondary element into the filter housing.

According to a beneficial embodiment of the filter system, the resonator can be connected to the end disk of the secondary element by a snap-on connection. In this manner, the resonator can be inserted in a simple manner into the secondary element and also be removed upon exchange of the secondary element. In this way, the resonator can be beneficially reused because it is substantially not subject to any wear.

According to a beneficial embodiment of the filter system, the resonator can be pushed from the end face of the secondary element into the opening of the end disk. In particular, the resonator can be connected by a snap-on connection to the end disk. In this manner, the resonator can be easily mounted and also removed again, as needed. A sealing action between resonator and end disk of the secondary element can be arranged beneficially at the end disk. In this context, expediently a circumferentially extending PUR seal or an O-ring seal or a 2K seal or a labyrinth seal can be used as a seal device. In this way, a safe sealing action even when exchanging the resonator is advantageously possible.

According to a beneficial embodiment of the filter system, the resonator can be connected to an end of the support structure of the secondary element positioned opposite the first end face of the filter element, in particular by a snap-on connection. In particular, the resonator can be arranged so as to be exchangeable from a clean fluid side. In this way, the resonator can be mounted at the secondary element in a beneficial manner and, when exchanging the secondary element, also can be easily removed and mounted in another secondary element. In this manner, the resonator which is subject to little wear can be beneficially reused.

Advantageously, the filter system can comprise at the closed side of the filter pack additional measures for reducing the sound emission. For example, a resonator structure as a parallel-connected resonator can be additionally integrated in the bottom of the filter pack. At the bottom, at least one resonator structure at the element can be formed for noise attenuation of a flowing fluid. The resonator structure at the element can comprise two grooves which are separated from each other by a partition, wherein at least one of the two grooves is connected through an opening to an interior of the filter pack. At an inner side of the housing bottom part, a resonator structure at the housing can be embodied which is complementary to the resonator structure at the element and which comprises two grooves separated from each other by a partition. Upon intended assembly of the filter system, the resonator structure at the element can seal tightly the resonator structure at the housing. The grooves at the element and at the housing can be connected in fluid communication at least to one of the two resonator structures through connection openings in at least one of the partitions.

The resonator structure at the housing can be formed at the inner side of the housing bottom part and can be embodied expediently to be mirror-symmetrically complementary to the resonator structure at the element. Upon installation of the filter element in the filter housing and closing of the filter housing with the housing bottom part, the two resonator structures interact and form two hollow spaces separated by partitions which enable a fluid exchange with each other through the connection openings in the partitions for noise attenuation. In this way, the actual resonator is formed by the two resonator structures matched to each other only once the filter system is assembled.

The sealing action of the two resonator structures can be realized by a suitable seal material, for example, polyurethane (PUR), which usually is employed for manufacturing an end disk of such a filter element by foaming PUR foam onto the bottom of the filter element. In this manner, the sealing action can be easily and reliably achieved and no additional production steps are required.

Such a parallel-connected resonator can be realized within a very limited installation space and can be produced inexpensively.

According to a further aspect of the invention, a filter element for use in a filter system is proposed with a hollow cylinder-type filter bellows arranged about its longitudinal axis, wherein the filter element at a first end face is embodied so as to be at least substantially closed and the first end face comprises at least one first end disk which is positioned opposite a second end disk with a fluid passage for the filtered fluid. With a filter element according to the invention, an advantageous use of a resonator in the filter system is possible in order to achieve in this way an effective noise attenuation of the flowing fluid in the filter system. This is in particular advantageous upon use in an air conducting system of an internal combustion engine, in particular in a motor vehicle.

The filter element can comprise at its first end face an end disk with an opening which, as described above, can be sealed by a resonator. In an alternative embodiment, the end disk can however also be embodied to be closed and the resonator arranged in the interior of the filter element.

The end disk can be embodied, for example, completely of PUR. In alternative embodiments, the end disk can however also be embodied as a plastic end disk, as a glued-on metal end disk, or as combination of an end disk of PUR and plastic material.

According to further aspect of the invention, a secondary element for use in a filter system is proposed, comprising a hollow cylinder-type filter bellows arranged about its longitudinal axis, wherein the secondary element comprises an end disk at an end face. With the secondary element according to the invention, an advantageous use of a resonator in the filter system is possible in order to achieve in this way an effective noise attenuation of the flowing fluid in the filter system. This is particularly advantageous in case of a use in an air conducting system of an internal combustion engine, in particular in a motor vehicle.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows an isometric illustration of a filter system according to an embodiment of the invention.

FIG. 2 shows a longitudinal section through a filter system according to an embodiment of the invention with resonator which closes an open end disk of a secondary element of a filter pack.

FIG. 3 shows an enlarged longitudinal section of the filter system according to FIG. 2 in the region of the end disks of the filter pack.

FIG. 4 shows a detail enlargement of FIG. 3.

FIG. 5 shows an enlarged longitudinal section of the filter system according to FIG. 2 in the region of the end disks of the filter pack with a seal device according to a further embodiment.

FIG. 6 shows a detail enlargement of FIG. 5.

FIG. 7 shows a longitudinal section through a filter system according to a further embodiment of the invention with resonator which closes an open end disk of a filter element of a filter pack.

FIG. 8 shows a detail enlargement of FIG. 7 in the region of the end disk of the filter element.

FIG. 9 shows a detail enlargement of FIG. 7 in the region of the end disk of the filter element with a seal device according to a further embodiment.

FIG. 10 shows a longitudinal section of a filter system according to a further embodiment of the invention with resonator which closes the open end disks of a filter element and of a secondary element of a filter pack.

FIG. 11 shows a detail enlargement of FIG. 10 in the region of the end disks of the filter pack.

FIG. 12 shows a detail enlargement of FIG. 10 in the region of the end disks of the filter pack with a seal device according to a further embodiment.

FIG. 13 shows a longitudinal section through a filter element with resonator according to a further embodiment in which the resonator is embodied as a part of the central tube of the filter element.

FIG. 14 shows the central tube with integrated resonator according to the embodiment of FIG. 13 in longitudinally sectioned isometric illustration.

FIG. 15 shows a longitudinal section through a filter system with resonator according to a further embodiment in which the resonator is embodied as part of an end disk of a secondary element.

FIG. 16 shows an exploded illustration of a filter system with resonator according to a further embodiment in which the resonator is embodied as part of a support structure of a secondary element.

FIG. 17 shows a longitudinally sectioned isometric illustration of the filter system according to FIG. 16.

FIG. 18 shows the secondary element of the filter system according to FIG. 17.

FIG. 19 shows a longitudinal section through a filter system with resonator according to a further embodiment in which the resonator is connected by a snap-on connection to an end disk of a secondary element.

FIG. 20 shows a detail enlargement of the snap-on connection of the resonator according to the embodiment in FIG. 19 in isometric illustration.

FIG. 21 shows the secondary element of the filter system according to FIG. 19 in longitudinally sectioned isometric illustration.

FIG. 22 shows an exploded illustration of a filter system with resonator according to a further embodiment in which the resonator is connected to an end of the central tube which is positioned opposite the first end face of the filter element.

FIG. 23 shows the filter element of the filter system according to FIG. 22 with mounted resonator in isometric illustration.

FIG. 24 shows a detail enlargement of the snap-on connection of the resonator according to FIG. 23.

FIG. 25 shows a longitudinal section through a filter system with resonator according to a further embodiment in which the resonator is pushed into an opening of an end disk of a secondary element.

FIG. 26 shows a detail enlargement of the snap-on connection of the resonator according to FIG. 25.

FIG. 27 shows a detail enlargement of a seal structure of the resonator according to FIG. 25.

FIG. 28 shows a longitudinally sectioned isometric illustration of the secondary element of the embodiment according to FIG. 25 in plain view of the end disk.

FIG. 29 shows an isometric illustration of the snap-on connection of the resonator according to FIG. 28.

FIG. 30 shows an exploded illustration of the secondary element with resonator of the embodiment according to FIG. 25.

FIG. 31 shows an isometric illustration of a filter element with resonator according to a further embodiment in which the resonator is pushed into an opening of an end disk of the filter element.

FIG. 32 shows the filter element according to FIG. 31 with mounted resonator.

FIG. 33 shows an isometric illustration of the snap-on connection of the resonator according to FIG. 31.

FIG. 34 shows a longitudinally sectioned isometric illustration of a filter system according to a further embodiment in which the resonator is mounted at the secondary element and is exchangeable from a clean fluid side.

FIG. 35 shows an exploded illustration of the secondary element with resonator of the embodiment according to FIG. 34.

FIG. 36 shows an isometric illustration of the snap-on connection of the resonator according to FIG. 34.

FIG. 37 shows a further embodiment of a filter system with an additional parallel-connected resonator with isometric view of a resonator structure at the filter element.

FIG. 38 shows an isometric view of the filter system with the filter pack of FIG. 37 with view of an inner side of the housing bottom part with a resonator structure at the housing.

### DESCRIPTION OF PREFERRED EMBODIMENTS

In the Figures, same or same-type components are identified with same reference characters. The Figures show only examples and are not to be understood as limiting.

The directional terminology used in the following with terms like Aleft@, Aright@, Atop@, Abottom@, Ain front of@, Abehind@, Aafter@, and the like serve only for better understanding the Figures and is not to represent a limitation of the generality in any case. The illustrated components and elements, their configuration and use can vary in the context of the considerations of a person of skill in the art and be adapted to the respective applications.

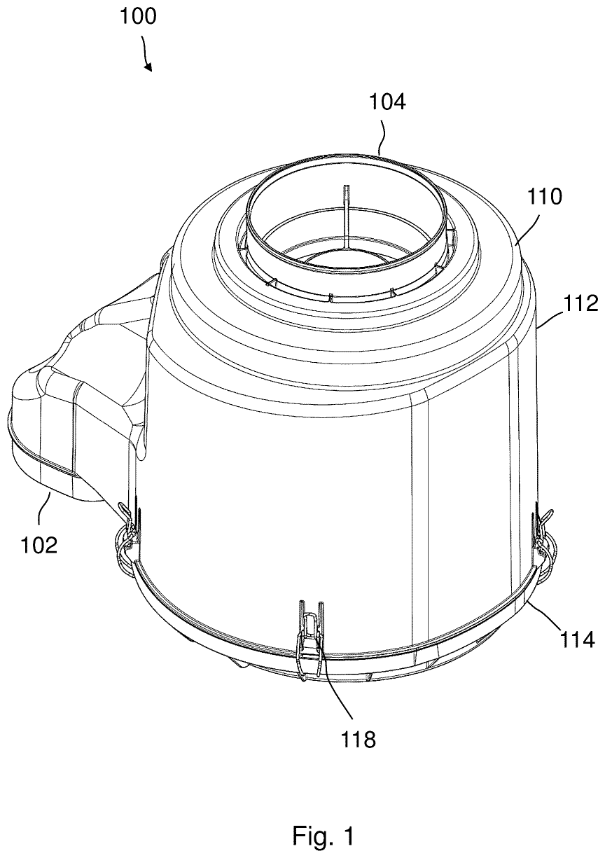

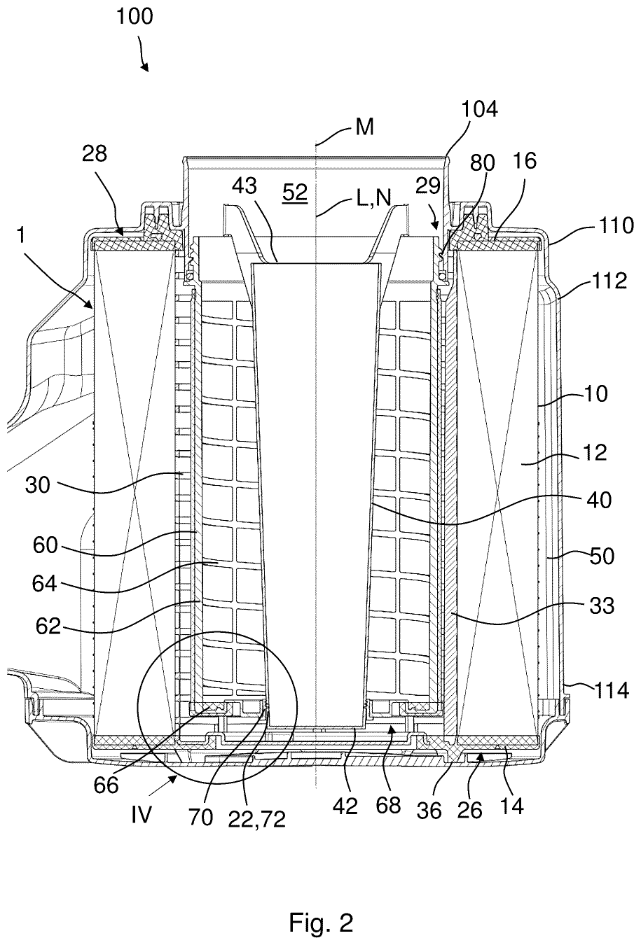

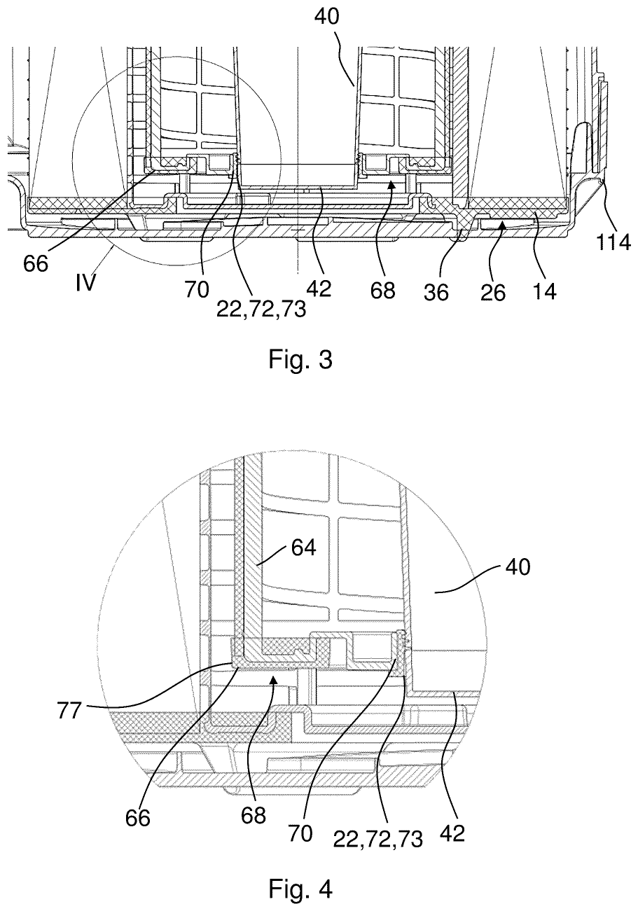

FIG. 1 shows an isometric illustration of a filter system 100 according to an embodiment of the invention while in FIG. 2 a longitudinal section through the filter system with resonator 40, which closes an open end disk 14 of a secondary element 60 of a filter pack 1, is illustrated. FIG. 3 shows an enlarged longitudinal section of the filter system according to FIG. 2 in the region of end disks 14, 66 of the filter pack 1. In FIG. 4, a detail enlargement of FIG. 3 can be seen.

The filter system 100 for filtering a fluid, in particular of an air conducting system of an internal combustion engine, in particular of a motor vehicle, comprises a filter housing 110 with a housing top part 112 and a housing bottom part 114 which extend along a housing axis M. The two housing parts 112, 114 are connected by connection elements 118, for example, clipped, so that the filter housing 110 can be easily opened, the housing bottom part 114 taken off, and the filter element 10 removed from the housing top part 112 for exchanging the filter element 10.

The filter system 100 comprises furthermore a filter pack 1 which fluid-tightly separates a clean fluid side 52 and a raw fluid side 50. The filter pack 1 comprises a filter element 10, wherein the filter element 10 comprises a hollow cylinder-type filter bellows 12 arranged about its longitudinal axis L. The filter element 10 comprises at a first end face 26 a first end disk 14 which is positioned opposite a second end disk 16 at a second end face 28 and comprises a fluid passage 29 for the filtered fluid.

The filter element 10 comprises a central tube 30 which is arranged concentrically in the interior of the filter bellows 12 and which supports the filter bellows 12 against the pressure of the fluid flowing radially from the exterior to the interior.

The filter pack 1 comprises furthermore a secondary element 60 with a hollow cylinder-type filter bellows 62 arranged about its longitudinal axis N, which is arranged inside the central tube 30 of the filter element 10, in particular concentrically to the housing axis M in the illustrated embodiment. The secondary element 60 comprises a support structure 64 which is arranged in the interior of the filter bellows 62 and which supports the filter bellows 62 against the forces of the fluid passing through the filter bellows 62.

The secondary element 60 is screwed by an inwardly positioned screw connection 80 to the housing top part 112 and serves, for example, to protect upon exchange of the filter element 10 the clean fluid outlet 104 and the further fluid tract from contamination. Also, the secondary element 60, in case of failure of the filter bellows 12 of the filter element 10, can take on at least part of the filtering action and thus also protect the clean fluid outlet 104 and the further fluid tract from contamination.

The secondary element 60 is embodied so as to be open at the upper end which is oriented toward the clean fluid outlet 104 and comprises an end disk 66 at an end face 68 at its oppositely positioned end 77.

The housing top part 112 comprises a lateral fluid inlet 102 through which the fluid, for example, air, can flow into the filter housing 110, flow through filter element 10 and secondary element 60 from the radially outwardly positioned raw fluid side 50 to the inwardly positioned clean fluid side 52, and exit, filtered, the filter housing 110 through a top-side fluid outlet 104.

The filter pack 1 comprises furthermore a resonator 40 with an end which is closed by a bottom 42. The resonator 40 is arranged in the interior of the filter pack 1 with its bottom 42 oriented toward the first end disk 14 of the filter element 10.

The resonator 40 is embodied as a tube which conically widens toward the open end 43.

In the embodiment illustrated in FIGS. 1 through 4, the resonator 40 is arranged concentrically to the longitudinal axis N in the interior of the secondary element 60 with the closed end (bottom 42) oriented toward the first end disk 14 of the filter element 10.

The resonator 40 and the filter pack 1 adjoin each other through a seal device 22. The open end 43 of the resonator 40 which is positioned opposite the bottom 42 is fastened in the region of the second end disk 16, for example, at the upper end of the support structure 64 of the secondary element 60.

The secondary element 60 comprises an end disk 66 with a central opening 70 through which the resonator 40 partially extends. The end disk 66 is connected to the support structure 64 of the secondary element 60 and comprises, for example, a profiled disk with the central opening 70 and foamed about with PUR.

The opening 70 of the end disk 66 seals tightly relative to the resonator 40.

The seal device 22 by means of which the resonator 40 is sealed against the end disk 66 of the secondary element 60 comprises a seal structure 72 which circumferentially surrounds the opening 70 and which in particular can be embodied as a 2K seal 73 or a PUR seal 75 or an O-ring seal 76 or a labyrinth seal.

In the embodiment illustrated in FIGS. 2 to 4, the seal structure 72 is embodied as a 2K seal 73 as can be seen in particular in the detail enlargement in FIG. 4. The seal structure 72 is injection molded onto the structure material of the end disk 66 and comprises a plurality of seal lips resting against the resonator 40.

The resonator 40 seals in this embodiment the opening 70 of the end disk 66 against the interior 33 of the filter element 10. In this manner, the clean fluid outlet 104 is effectively sealed by the secondary element 60 in relation to the environment when the filter element 10 is removed during an exchange or the filter bellows 12 of the filter element 10 fails. The secondary element 60 can thus effectively fulfill its protective function.

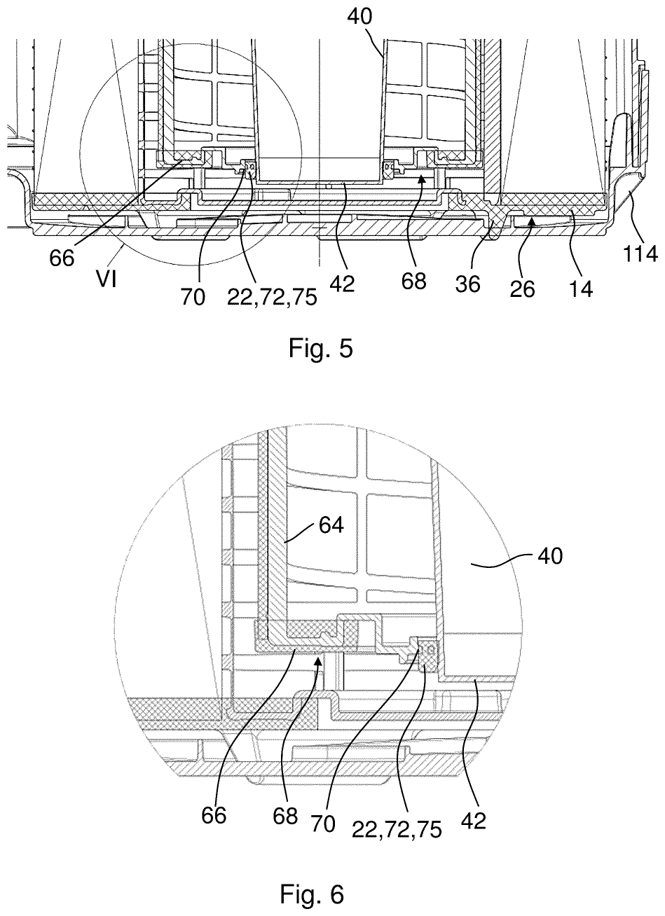

In an enlarged longitudinal section of the filter system 100 according to FIG. 2, a seal device 22 with a seal structure 72 according to a further embodiment is illustrated in FIG. 5 in the region of the end disk 66 of the secondary element 60 and is embodied as PUR seal 75. The end disk 66 itself is embodied as in the preceding embodiment.

FIG. 6 shows in this context a detail enlargement of FIG. 5. The PUR seal 75 is foamed onto the structure material of the end disk 66 and, with the resonator 40 pushed through the opening 70, rests against the resonator wall 41 and seals thus relative to the resonator wall 41. Thus, the secondary element 60 is effectively sealed relative to the interior 33 of the filter element 10.

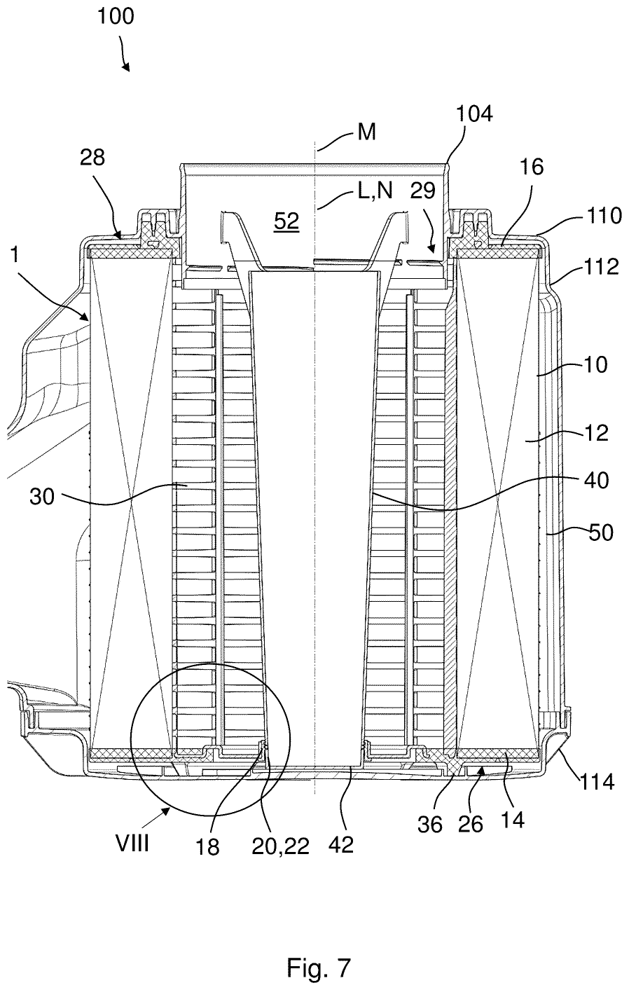

In FIG. 7, a longitudinal section through a filter system 100 according to a further embodiment of the invention with resonator 40, which closes an open end disk 14 of a filter element 10 of a filter pack 1, is illustrated. The filter system 100 comprises no secondary element in this example.

The first end disk 14 of the filter element 10 comprises an opening 18 through which the resonator 40 extends partially. In this context, the opening 18 of the end disk 14 seals relative to the resonator 40. The opening 18 of the end disk 14 can seal fluid-tightly relative to the resonator 40. An acoustic sealing action can be sufficient when the seal location is located at the clean side of the filter element, in particular of the main element. The first end disk 14 comprises in this context a seal structure 20 surrounding the opening 18 as a seal device 22 which can be embodied in particular as a PUR seal 24 or an O-ring seal 25 or 2K seal 23 or as plastic/plastic seal in the form of a labyrinth seal.

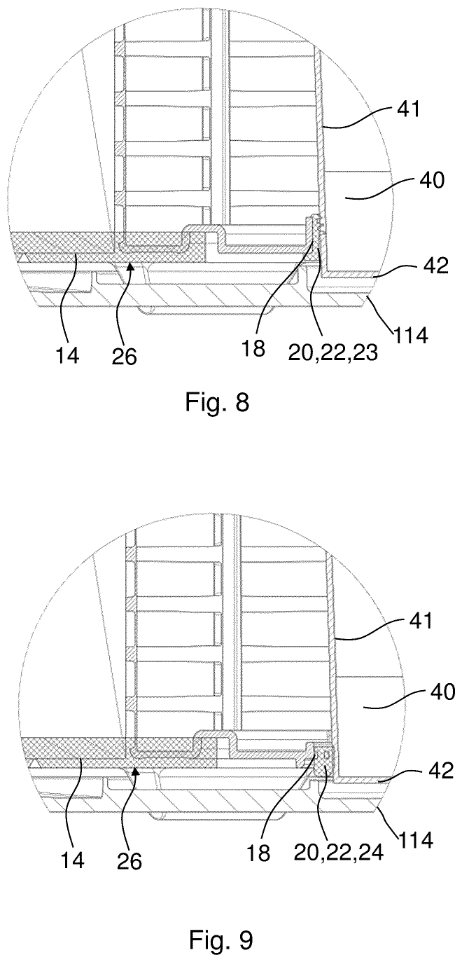

FIG. 8 shows a detail enlargement of FIG. 7 in the region of the end disk 14 of the filter element 10 with a seal device 22 embodied as a 2K seal 23 while a detail enlargement of FIG. 7 in the region of the end disk 14 of the filter element 10 with a seal device 22 according to a further embodiment in the form of a PUR seal 24 is illustrated in FIG. 9.

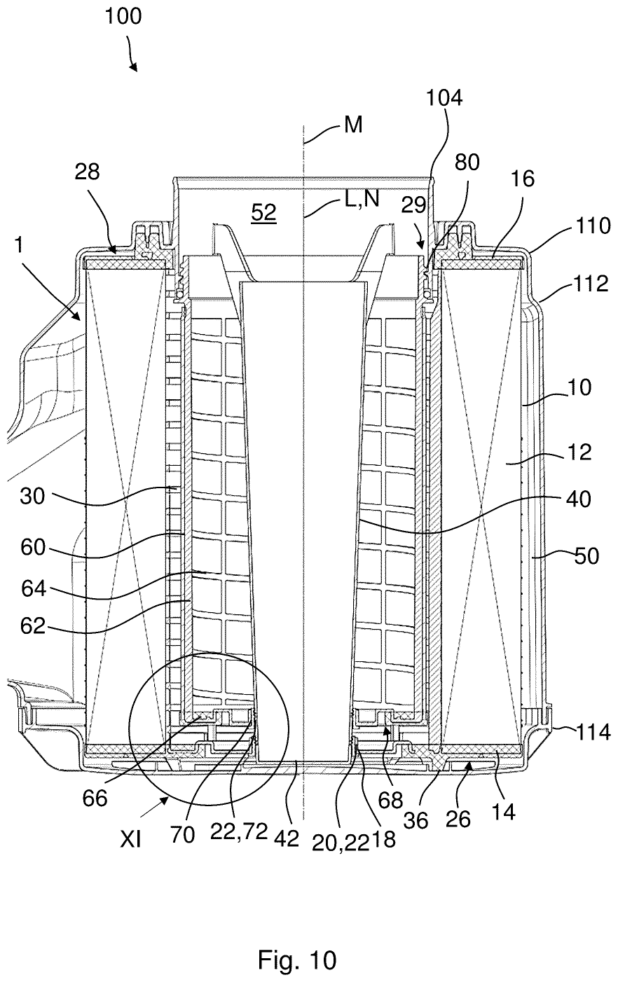

FIG. 10 shows a longitudinal section through a filter system 100 according to a further embodiment of the invention with resonator 40 which closes the open end disks 14, 66 of a filter element 10 and of a secondary element 60 of a filter pack 1. Both end disks 14, 66 of the filter element 10 as well as of the secondary element 60 comprise central openings 18 or 70 through which the resonator 40 extends and, in this way, closes and seals the end disks 14, 66.

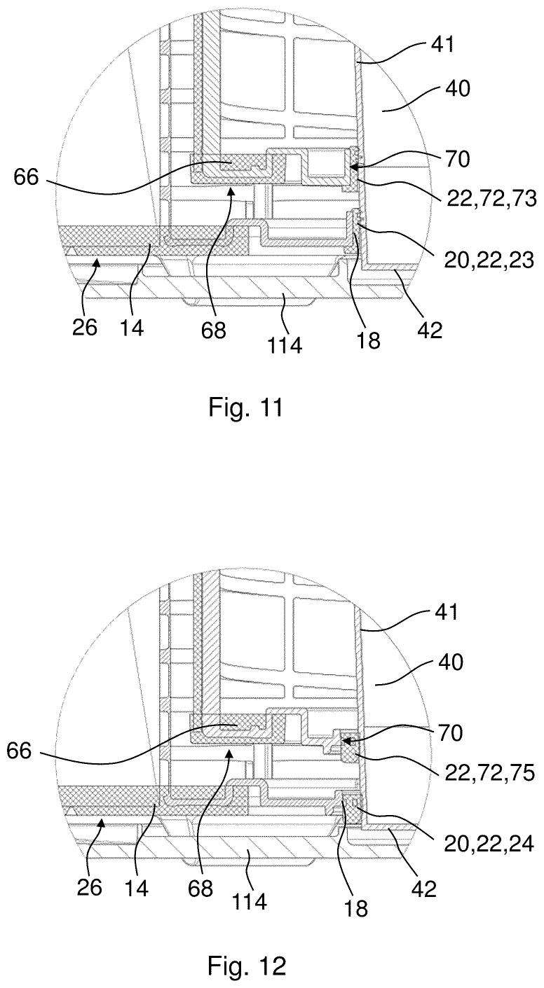

FIG. 11 shows in this context a detail enlargement of FIG. 10 in the region of the end disks 14, 66 of the filter pack 1. In this embodiment, the seal structures 20, 72 are embodied as 2K seals 23, 73 which are injection molded at the openings 18, 70 of the end disks 14, 66 and seal-tightly rest with seal lips against the resonator wall 41 when the resonator 40 has been pushed in.

FIG. 12 shows a detail enlargement of FIG. 10 in the region of the end disk 14, 66 of the filter pack 1 with a seal device 22 according to a further embodiment in which the seal structures 20, 72 are embodied as PUR seals 24, 75 foamed at the openings 18, 70 of the end disks 14, 66 and seal-tightly rest against the resonator wall 41 when the resonator 40 has been pushed in.

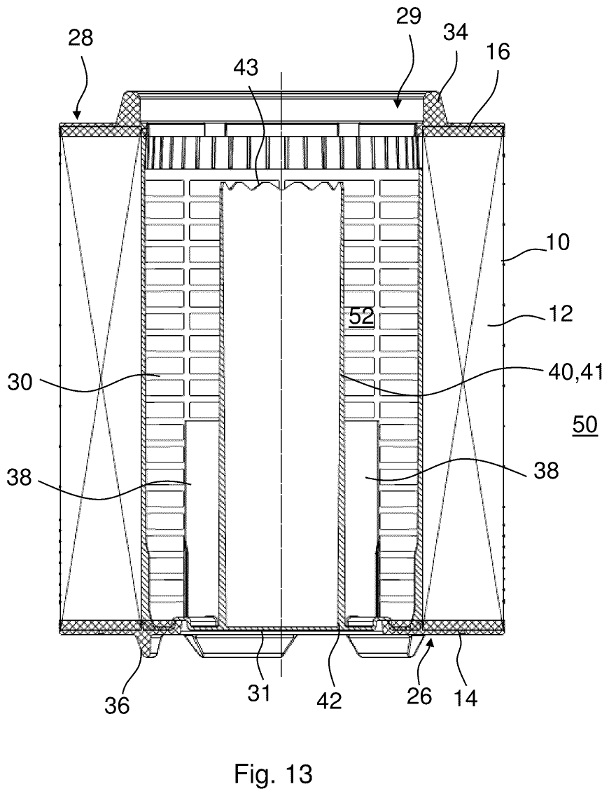

In FIG. 13, a longitudinal section through a filter element 10 with resonator 40 according to a further embodiment is illustrated in which the resonator 40 is embodied as part of the central tube 30 of the filter element 10.

The filter element 10 comprises the hollow cylinder-type filter bellows 12 which is closed by the end disks 14, 16 at the two oppositely positioned end faces 26, 28. The first end disk 14 comprises individual support elements 36 with which the filter element 10 can rest on the housing bottom part 114 of a filter housing 110. The second end disk 16 comprises a support structure 34 embodied as a circular bead with which the filter element 10 can be supported at the housing top part 112.

The filter bellows 12 is supported at the inner side by the central tube 30 against the pressure of the flowing fluid which flows from the outwardly positioned raw fluid side 50 to the inwardly positioned clean fluid side 52.

In this embodiment, the bottom 42 of the resonator 40 is integrated in a bottom 31 of the central tube 30 of the filter pack 1. In this way, the resonator 40 is formed as one piece together with the central tube 30 and can be produced inexpensively. In addition, the resonator 40 thus must not be mounted in a separate working step.

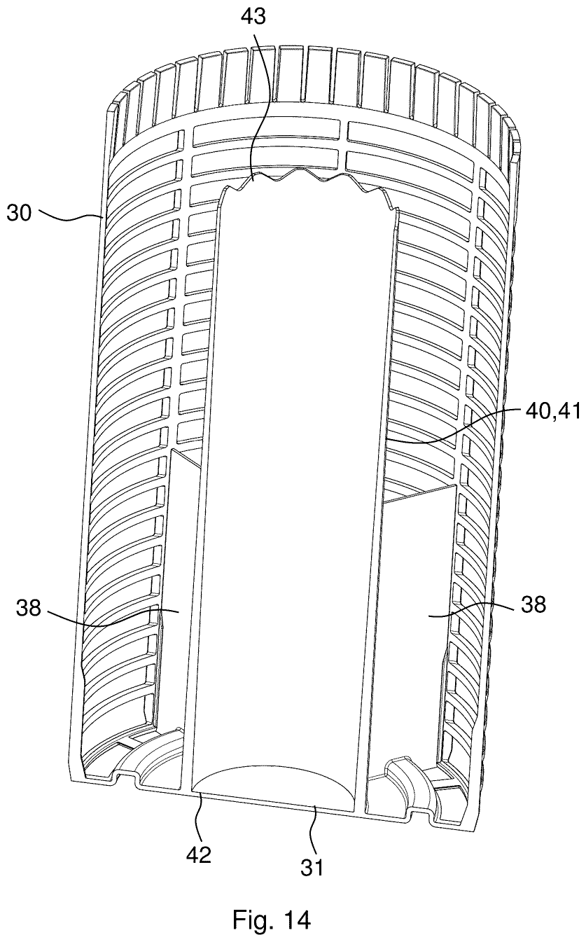

FIG. 14 shows in this context the central tube 30 with integrated resonator 40 according to the embodiment of FIG. 13 in longitudinally sectioned isometric illustration. The resonator 40 is connected to the central tube 30 and stabilized by a plurality of reinforcement elements 38 extending radially from the resonator wall 41 toward the central tube 30. The reinforcement elements 38 are also connected to the central tube forming one piece therewith.

The open end 43 of the resonator comprises a zigzag rim. In this way, acoustic attenuation properties of the resonator 40 can be achieved particularly advantageously.

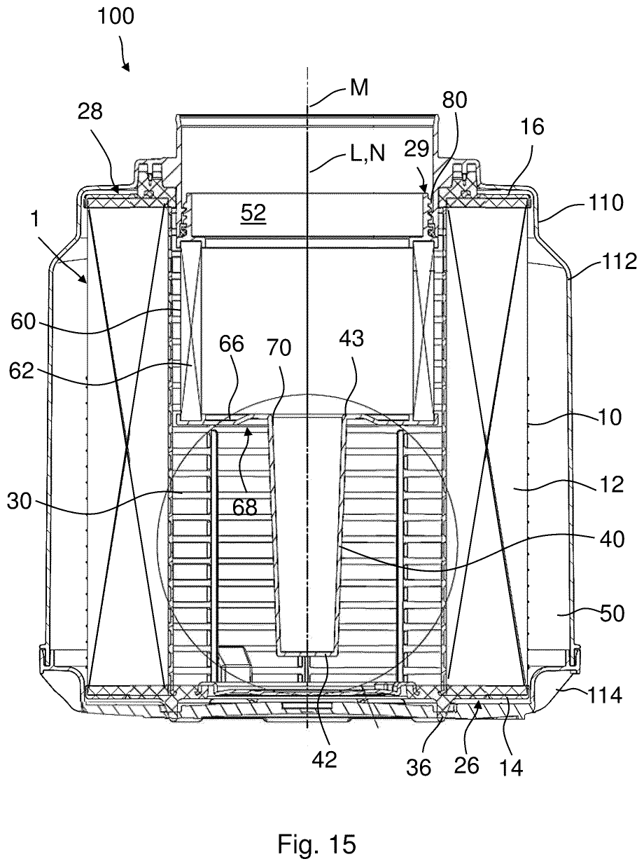

In FIG. 15, a longitudinal section through a filter system 100 with resonator 40 according to further embodiment is illustrated in which the resonator 40 is embodied as part of an end disk 66 of a secondary element 60.

The secondary element 60 arranged in the interior of the filter element 10 comprises a height which corresponds only to approximately half the height of the filter element 10. By means of a screw connection 80, the secondary element 60 is arranged in the upper part of the filter housing 110 in the central tube 30 at the level of the second end disk 16 of the filter element. The end disk 66 of the secondary element 60 arranged in the region of the end face 68 comprises a central opening 70 which passes into the open end 43 of the resonator 40. The resonator is arranged in regard to its length outside of the secondary element 60 and is oriented with its bottom 42 as the closed end toward the first end disk 14 of the filter element 10. Advantageously, the resonator 40 can be embodied as one piece together with the end disk 66 of the secondary element 60 or with a support structure 64 (not illustrated) of the secondary element 66.

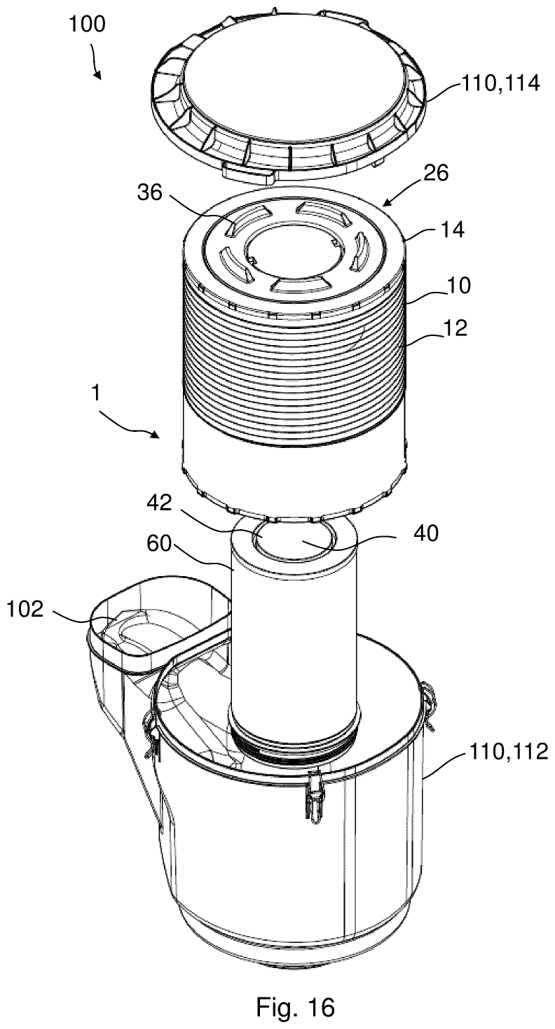

FIG. 16 shows an exploded view of a filter system 100 with resonator 40 according to a further embodiment in which the resonator 40 is embodied as part of a support structure 64 of a secondary element 60. The view is illustrated from the side of the housing bottom part 114 of the filter housing 110. Of the resonator 40 as part of the secondary element 60 only its bottom 42 can be seen.

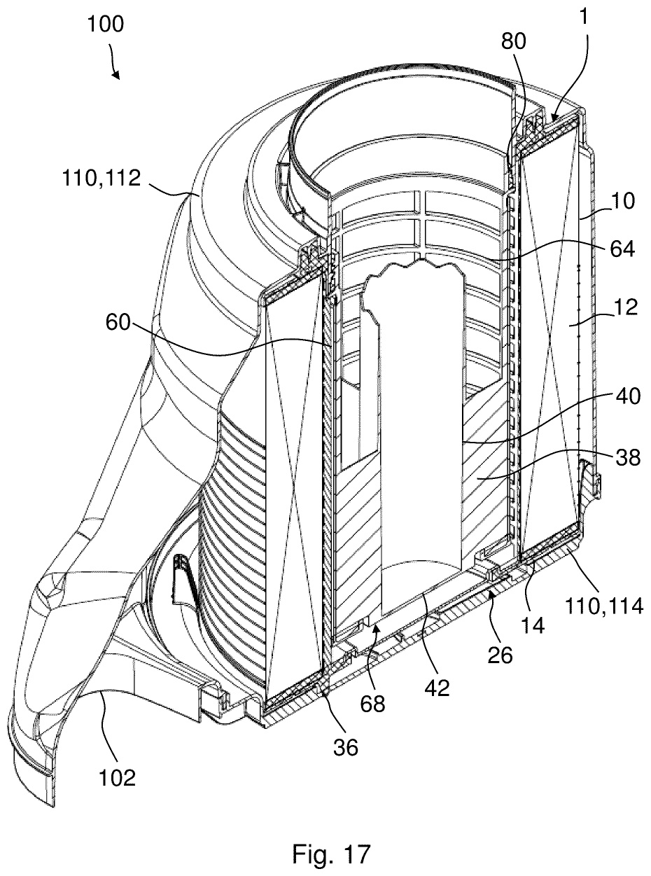

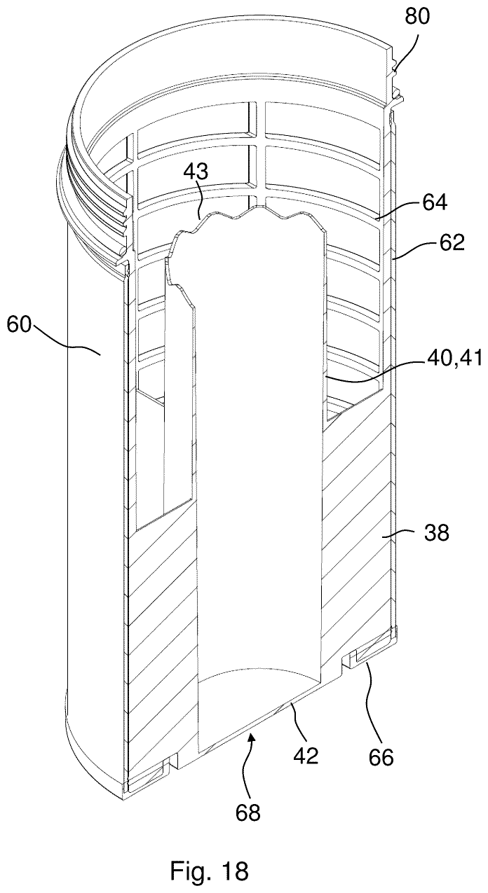

In this context, a longitudinally sectioned isometric illustration of the filter system 100 according to FIG. 16 is illustrated in FIG. 17 while the secondary element 60 of the filter system 100 with resonator 40 is illustrated in FIG. 18.

The resonator 40 in this embodiment is connected to the support structure 64 of the secondary element 60 and can be embodied in particular as one piece together with the support structure 64. The resonator wall 42 of the resonator 40 is connected with reinforcement elements 38 to the support structure 64 for stabilizing the resonator 40. The reinforcement elements 38 can be embodied in particular also as one piece together with the support structure 64. The open end 43 of the resonator 40 can be embodied as a zigzag end for acoustic reasons.

The end disk 66 of the secondary element 60 can be foamed to the support structure 64, for example, with PUR. The secondary element 60 can comprise radially outwardly of the support structure 64 a filter bellows 62 which can be embodied also as a nonwoven.

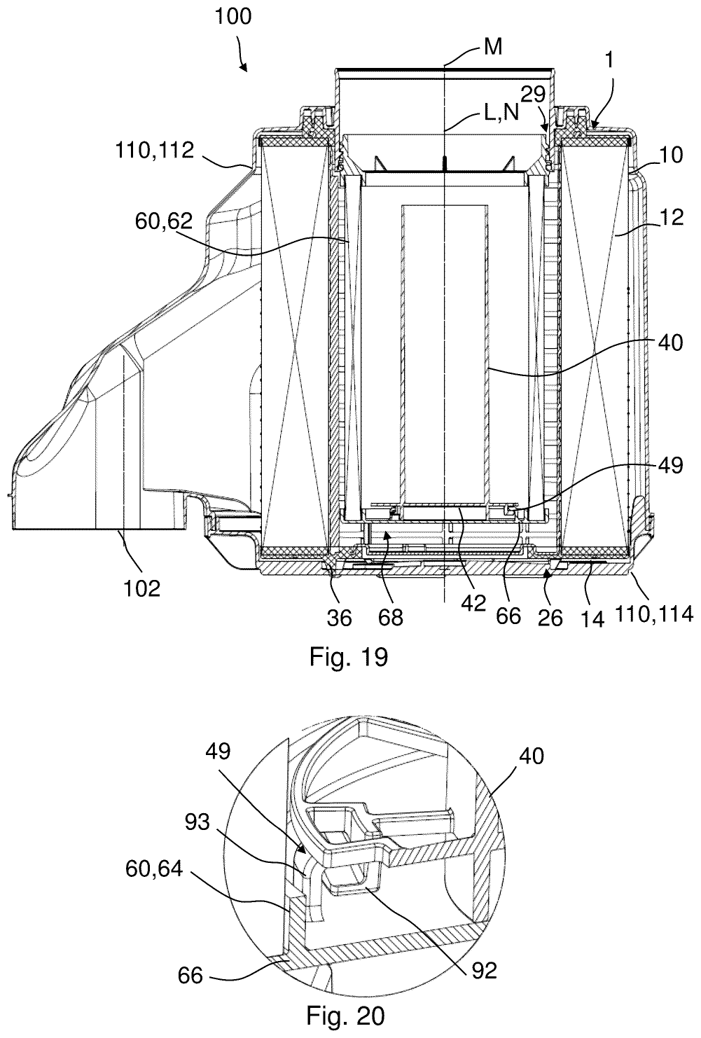

FIG. 19 shows a longitudinal section through the filter system 100 with resonator 40 according to a further embodiment in which the resonator 40 is connected by a snap-on connection 49 to an end disk 66 of a secondary element 60. The resonator 40 is arranged with its bottom 42 as the closed end in the region of the end disk 66 of the secondary element 60. The end disk 66 is connected to the support structure 64 of the secondary element 60.

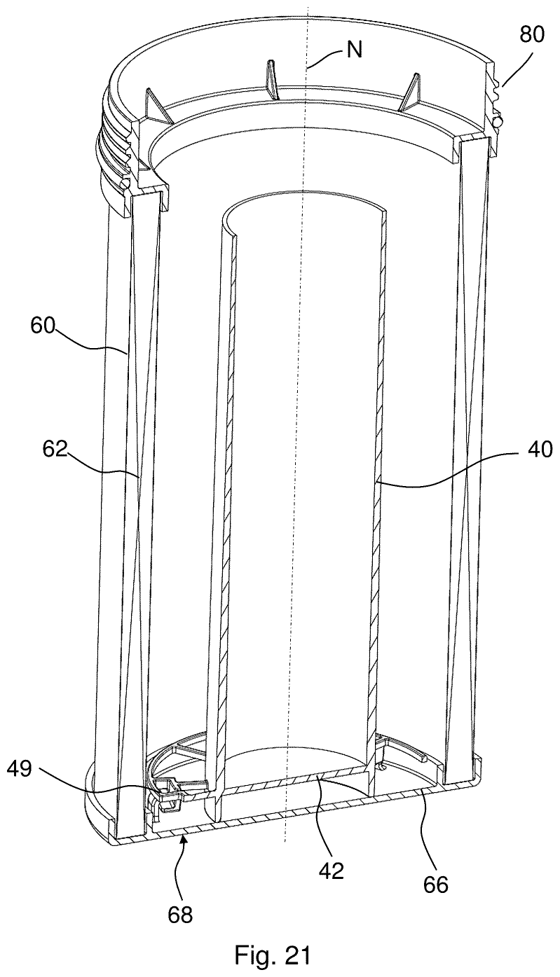

FIG. 20 shows a detail enlargement of the snap-on connection 49 of the resonator 40 according to the embodiment in FIG. 19 in isometric illustration while in FIG. 21 the secondary element 60 is illustrated in longitudinally sectioned isometric illustration.

The snap-on connection 49 comprises a plurality of snap-on elements 92 at the resonator arranged about the circumference of the resonator 40 which, by a rotary movement of the resonator 40 about the longitudinal axis N of the secondary element 60, can lock with a plurality of snap-on elements 93 at the support structure which are embodied complementary thereto. In this way, the resonator 40 can be connected to the support structure 64 or the end disk 66 of the secondary element 60 in that the resonator 40 in the interior of the secondary element 60 is placed onto the end disk 66 and rotated about the longitudinal axis N. The bottom 42 of the resonator 40 in this embodiment is arranged at the level of the snap-on connection 49 in order to achieve a beneficial reinforcement of the snap-on elements 92 at the resonator. The snap-on elements 93 at the support structure are fixedly connected to the support structure 64 of the secondary element 60.

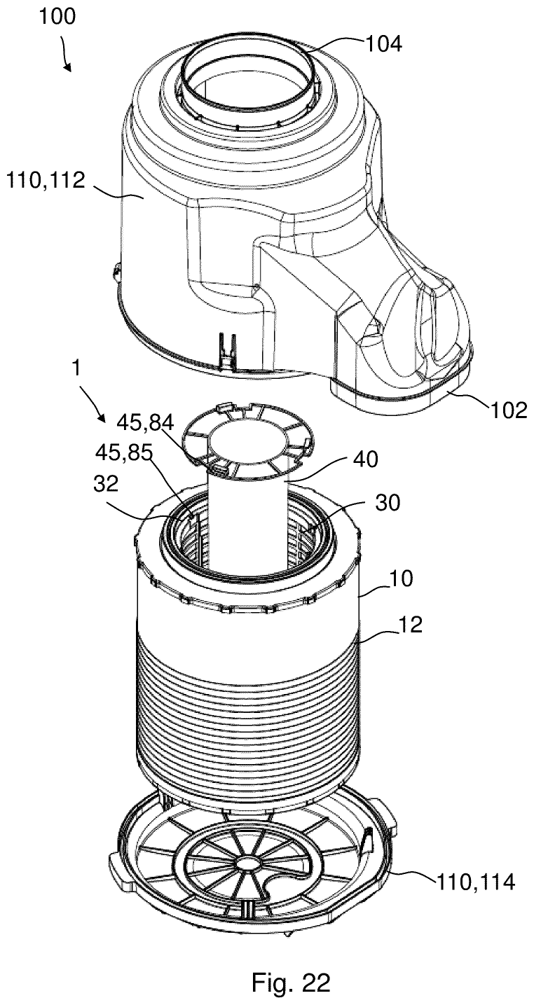

FIG. 22 shows an exploded illustration of a filter system 100 with resonator 40 according to a further embodiment in which the resonator 40 is connected to an end 32 of the central tube 30 which is positioned opposite the first end face 26 of the filter element 10. In this context, the filter element 10 of the filter system 100 according to FIG. 22 is illustrated in FIG. 23 with mounted resonator 40 in isometric illustration. The resonator 40 in this embodiment is connected by a snap-on connection 45 to the central tube 30 and can thus be exchanged from the clean fluid side 52.

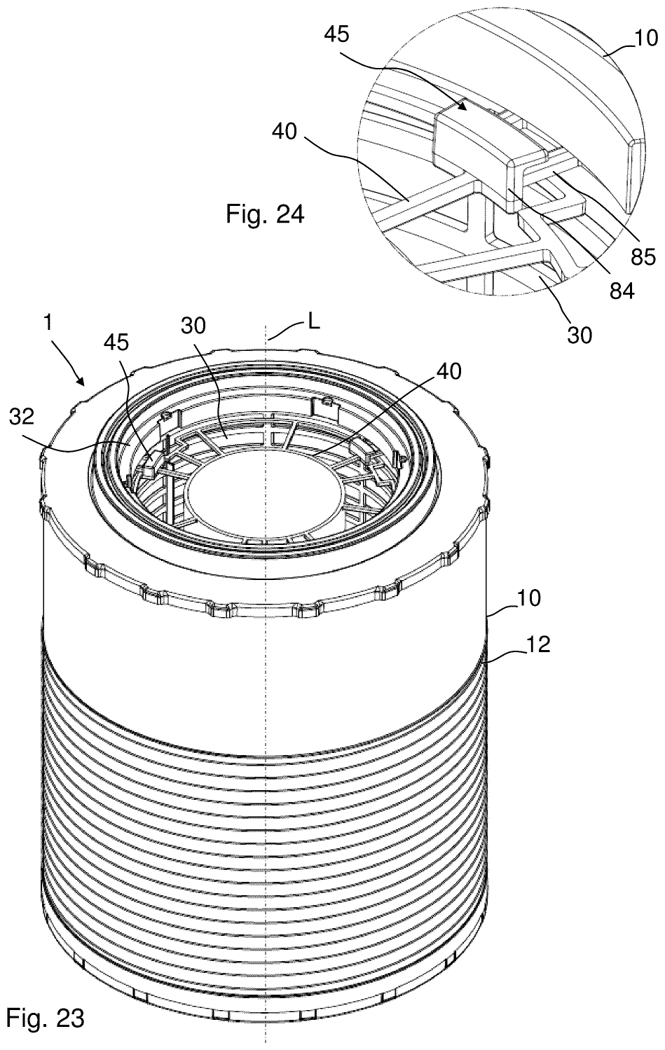

FIG. 24 shows a detail enlargement of the snap-on connection 45 of the resonator 40 according to FIG. 23.

The snap-on connection 45 comprises a plurality of snap-on elements 84 at the resonator arranged about the circumference of the resonator 40 which by a rotary movement of the resonator 40 about the longitudinal axis L of the filter element 10 can lock with a plurality of snap-on elements 85 at the central tube which are embodied complementary thereto. In this way, the resonator 40 can be connected to the central tube 30 of the filter element 10 in that the resonator 40 is rotated in the interior of the filter element 10 about the longitudinal axis L. The snap-on elements 85 at the central tube are fixedly connected to the central tube 30 of the filter element 10.

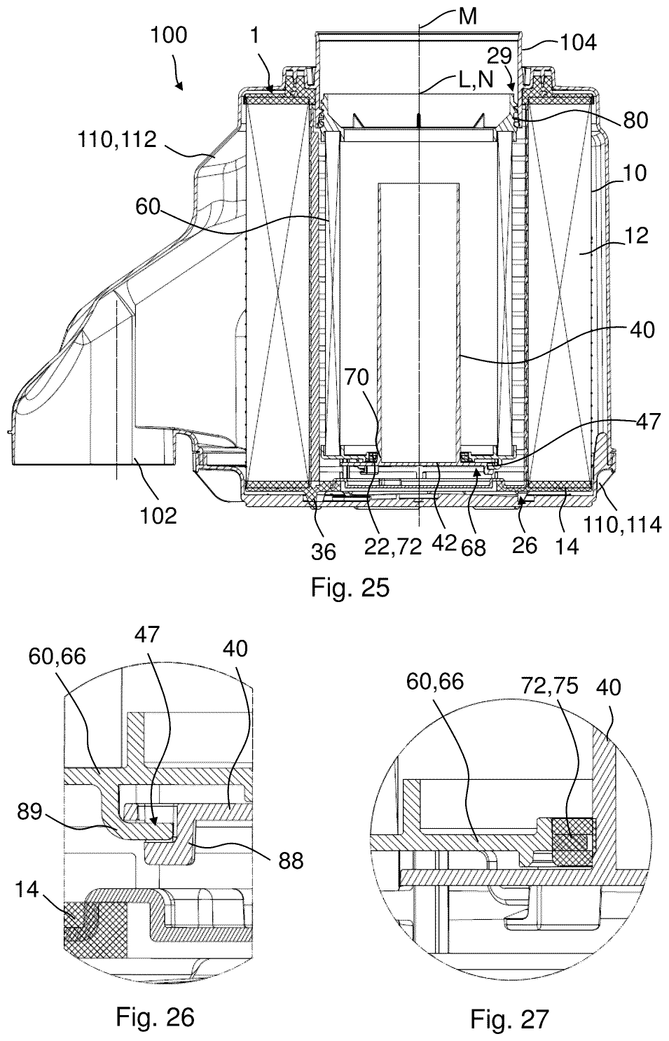

FIG. 25 shows a longitudinal section through a filter system 100 with resonator 40 according to a further embodiment in which the resonator 40 is pushed into an opening 70 of an end disk 66 of a secondary element 60. Advantageously, the resonator 40 in this context is connected by a snap-on connection 47 to the end disk 66.

FIG. 26 shows a detail enlargement of the snap-on connection 47 of the resonator 40 according to FIG. 25 while in FIG. 27 a detail enlargement of a seal structure 72 of the resonator 40 is illustrated. The seal structure 72 comprises in this embodiment a PUR seal 75 which is foamed onto the end disk 66 of the secondary element 60 and seal-tightly rests against the resonator wall 41 of the resonator 40 when the resonator 40 has been mounted.

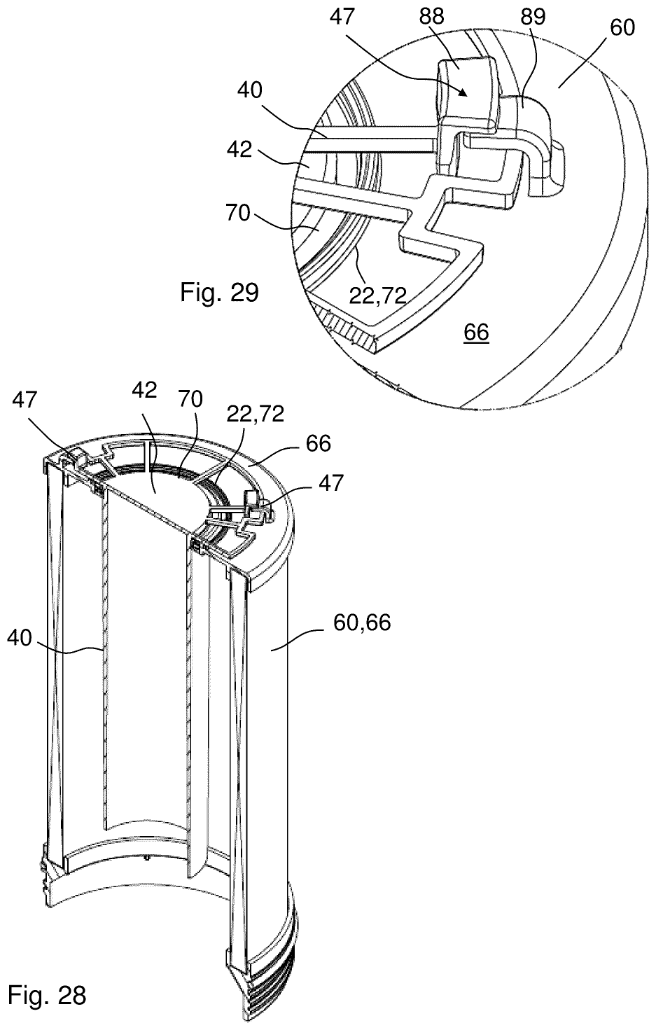

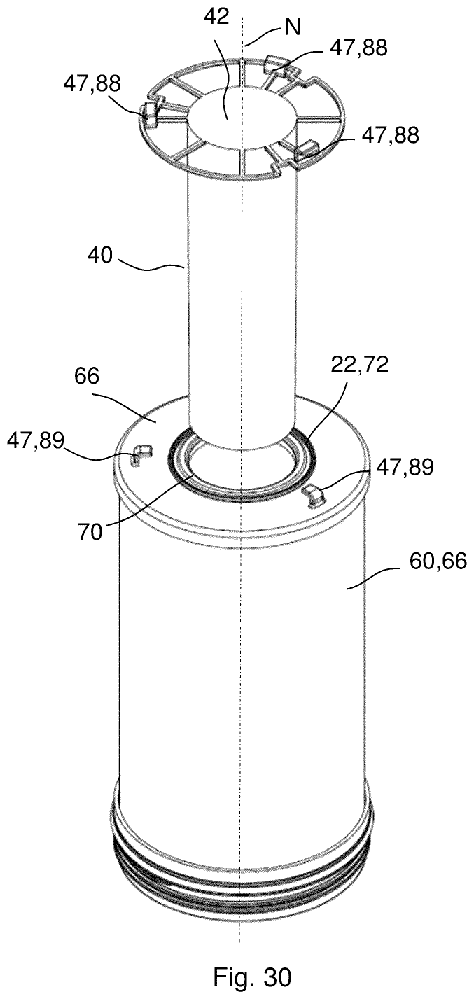

FIG. 28 shows a longitudinally sectioned isometric illustration of the secondary element 60 in plain view of the end disk 66 while in FIG. 29 an isometric illustration of the snap-on connection 47 of the resonator 40 is illustrated. FIG. 30 shows an exploded illustration of the secondary element 60 with resonator 40.

The snap-on connection 47 comprises a plurality of snap-on elements 88 at the resonator arranged about the circumference of the resonator 40 which by a rotary movement of the resonator 40 about the longitudinal axis N of the secondary element 66 can lock with a plurality of complementary snap-on elements 89 at the end disk which are embodied complementary thereto. Thus, the resonator 40 can be connected to the end disk 66 of the secondary element 60 in that the resonator 40 is rotated in the interior of the secondary element 60 about the longitudinal axis N. The snap-on elements 89 at the end disk are fixedly connected to the end disk 66 of the secondary element 60.

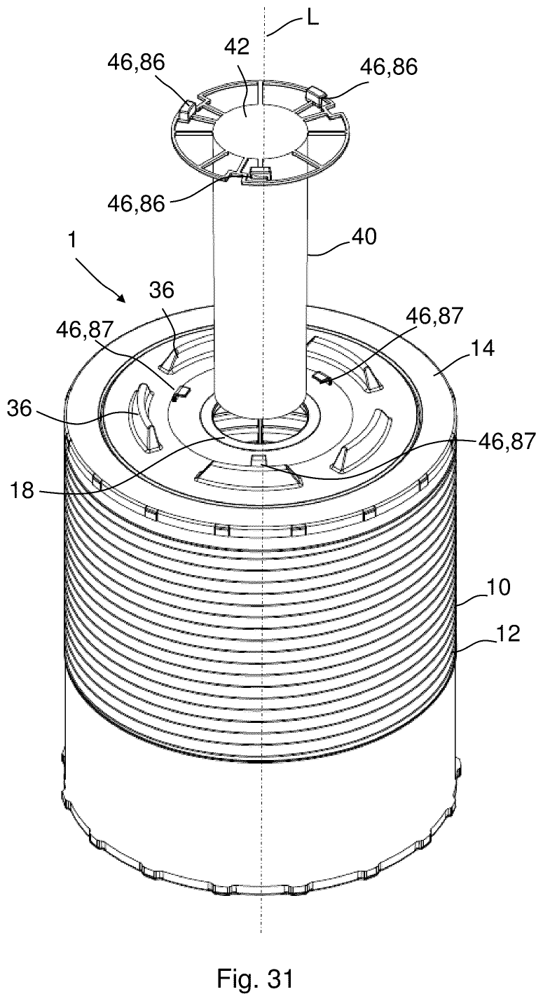

FIG. 31 shows an isometric illustration of a filter element 10 with resonator 40 according to a further embodiment in which the resonator 40 is pushed into an opening 18 of an end disk 14 of the filter element 10.

The resonator 40 is pushed from the first end face 26 of the filter element 10 into the opening 18 of the end disk 14. In this context, the resonator 40 is connected in particular by a snap-on connection 46 to the end disk 14.

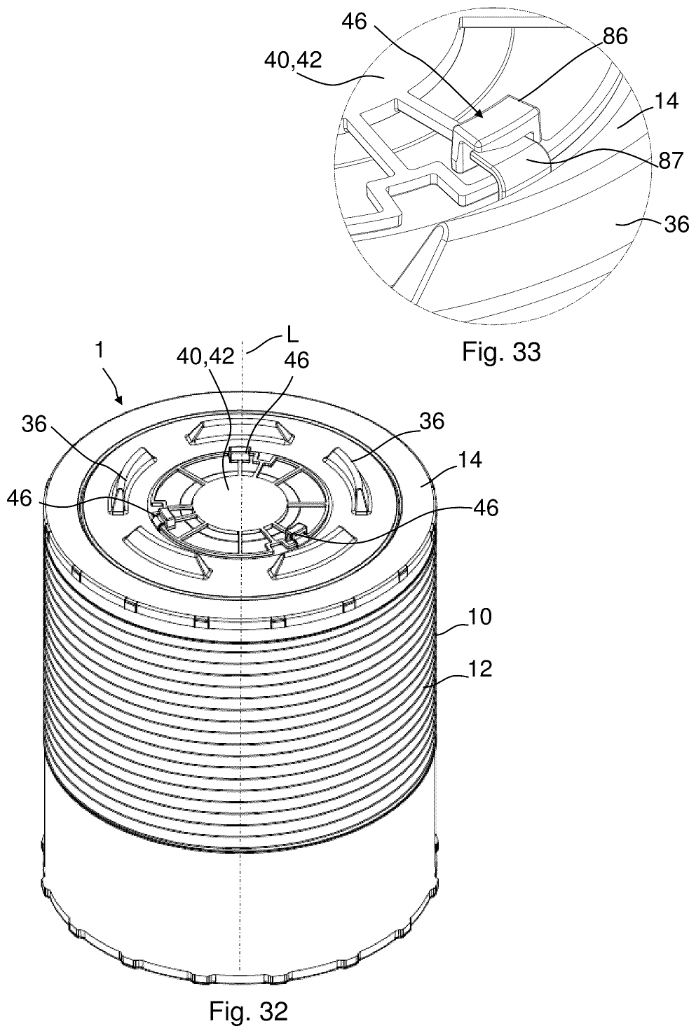

FIG. 32 shows the filter element 10 according to FIG. 31 with mounted resonator 40 while in FIG. 33 an isometric illustration of the snap-on connection 46 of the resonator 40 is illustrated.

The snap-on connection 46 comprises a plurality of snap-on elements 86 at the resonator arranged about the circumference of the resonator 40 which by a rotary movement of the resonator 40 about the longitudinal axis L of the filter element 10 can lock with a plurality of snap-on elements 87 at the end disk which are embodied complementary thereto. Thus, the resonator 40 can be connected to the central tube 30 of the filter element 10 in that the resonator 40 in the interior of the filter element 10 is rotated about the longitudinal axis L. The snap-on elements 87 at the end disk are fixedly connected to the end disk 14 of the filter element 10.

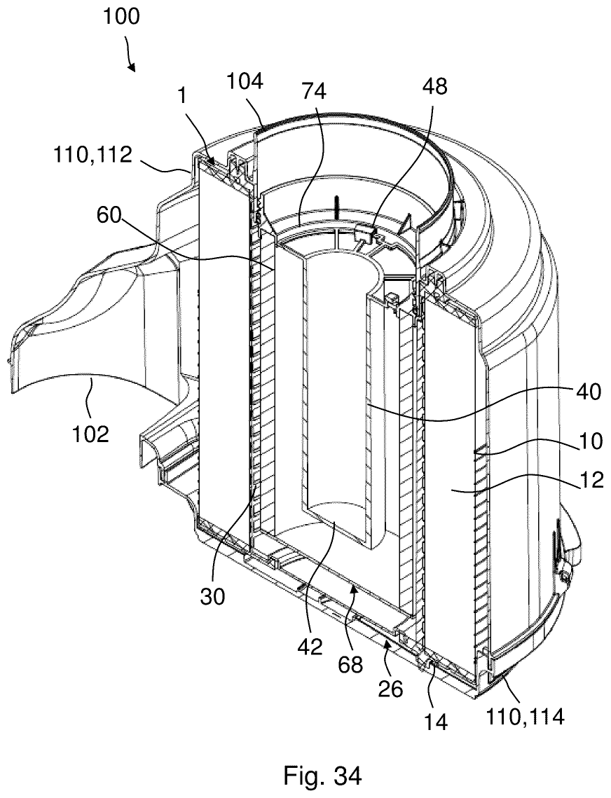

FIG. 34 shows a longitudinally sectioned isometric illustration of a filter system 100 according to a further embodiment in which the resonator 40 is mounted at the secondary element 60 and is exchangeable from a clean fluid side.

The resonator 40 is connected to an end 74 of the support structure 64 of the secondary element 60, which is positioned opposite the first end face 26 of the filter element 10, by a snap-on connection 48. In this manner, the resonator 40 can be exchanged beneficially from a clean fluid side 52.

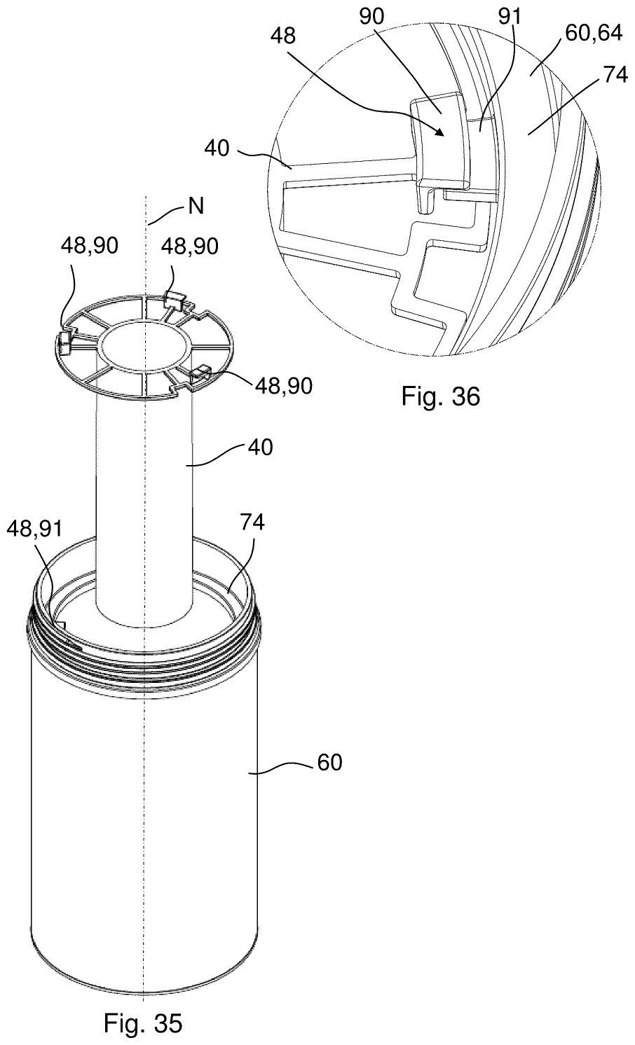

FIG. 35 shows an exploded illustration of the secondary element 60 with resonator 40 of the embodiment according to FIG. 34 while in FIG. 36 an isometric illustration of the snap-on connection 48 of the resonator 40 is illustrated.

The snap-on connection 48 comprises a plurality of snap-on elements 90 at the resonator arranged about the circumference of the resonator 40 which by a rotary movement of the resonator 40 about the longitudinal axis N of the secondary element 60 can lock with a plurality of snap-on elements 91 at the support structure which are embodied complementary thereto. Thus, the resonator 40 can be connected to the support structure 64 of the secondary element 60 in that the resonator 40 in the interior of the secondary element 60 is rotated about the longitudinal axis N. The snap-on elements 91 at the support structure are fixedly connected to the support structure 64 of the secondary element 60.

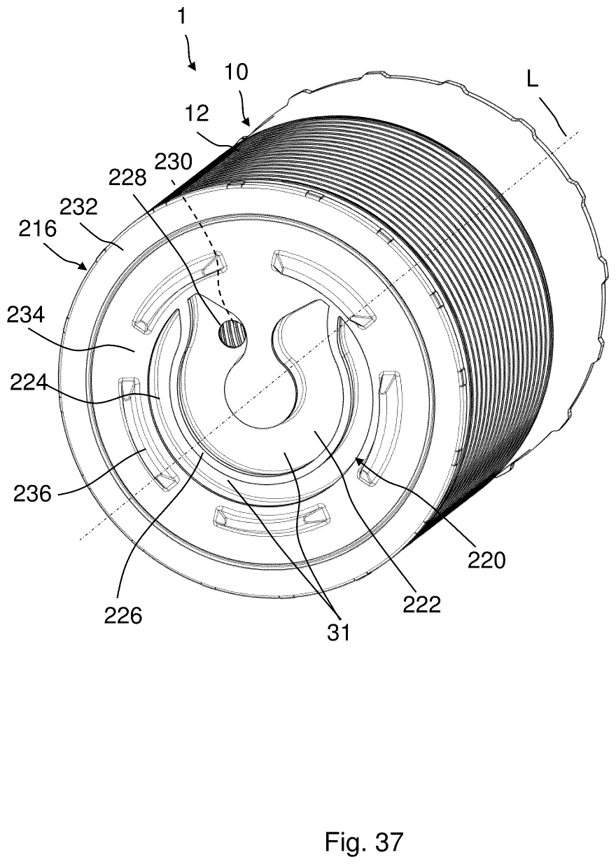

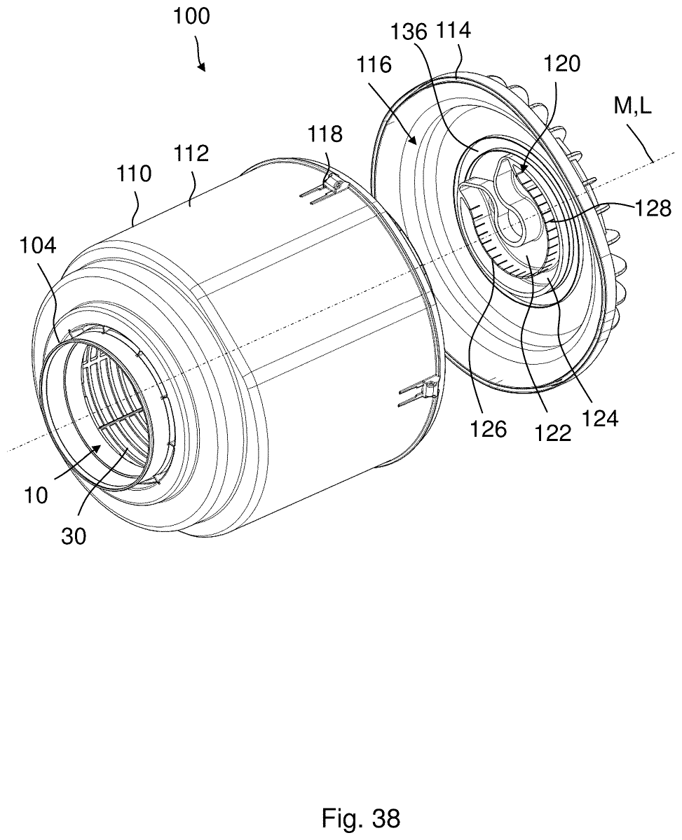

FIGS. 37 and 38 show a further embodiment of a filter system 100 with an additional parallel-connected resonator outside of the filter pack 1. FIG. 37 shows an isometric view of a resonator structure 220 at the filter element and FIG. 38 an isometric view of the filter system 100 with the filter pack 1 of FIG. 37 with a view of an inner side 116 of the housing bottom part 114 with resonator structure 120 at the housing.

Advantageously, the filter system 100 can comprise at the closed side of the filter pack 1 additional measures for reducing the sound emission. Thus, in a bottom 31 of the filter pack 1 additionally a resonator structure 220 as a parallel-connected resonator can be integrated. The bottom 31 can advantageously be embodied as a bottom of the central tube 30 of the filter element 10 which supports the filter bellows 12 from an inner side against the pressure of the flowing fluid. At the bottom 31, at least one resonator structure 220 at the element can be embodied for noise attenuation of a flowing fluid. The resonator structure 220 at the element can comprise two grooves 222, 224 separated from each other by a partition 226, wherein at least one of the two grooves 222, 224 is connected by an opening 228 to an interior 230 of the filter pack 1. At an inner side 116 of the housing bottom part 114, a resonator structure 120 at the housing can be embodied which is complementary to the resonator structure 220 at the element and comprises two grooves 122, 124 separated by a partition 126. For intended assembly of the filter system 100, the resonator structure 220 at the element can seal tightly the resonator structure 120 at the housing. The grooves 222, 224, 122, 124 at the element and at the housing can be connected in fluid communication at least to one of the two resonator structures 220, 120 through connection openings 128 in at least one of the partitions 126.

The resonator structure 120 at the housing can be embodied at the inner side 116 of the housing bottom part 114 and expediently can be embodied mirror-symmetrically complementary to the resonator structure 220 at the element. Upon installation of the filter element 10 in the filter housing 110 and closing of the filter housing 110 with the housing bottom part 114, the two resonator structures 220, 120 interact and together form two hollow spaces separated by partitions 226, 126 which, through connection openings 128 in the partitions 226, 126, enable a certain fluid exchange with each other for noise attenuation. Thus, the actual resonator is formed only once the filter system 100 with the two resonator structures 220, 120 matched to each other is assembled.

The sealing action of the two resonator structures 220, 120 can be realized by a seal structure 234 with a suitable seal material, for example, polyurethane (PUR) which is usually employed for producing an end disk 232 of such a filter element 10 by foaming PUR foam to an end face 216 of the bottom 31 of the filter element 10. In this manner, the sealing action can be simply and reliably achieved and no additional processing steps are required. In the thus formed end disk 232, support elements 236 can be integrated also for supporting the filter element 10 on the inner side 116 of the housing bottom part 114 upon mounting of the filter element 10 in the filter housing 110.

### REFERENCE CHARACTERS

1 filter pack
10 filter element
12 filter bellows
14 first end disk
16 second end disk
18 opening
20 seal structure
22 seal device
23 2K seal
24 PUR seal
25 O-ring seal
26 first end face
28 second end face
29 fluid passage
30 central tube
31 bottom
32 end
33 interior
34 support structure
36 support element
38 reinforcement element
40 resonator
41 resonator wall
42 bottom
43 end
45 snap-on connection
46 snap-on connection
47 snap-on connection
48 snap-on connection
49 snap-on connection
50 raw fluid region
52 clean fluid region
60 secondary element
62 filter bellows
64 support structure
66 end disk
68 end face
70 opening
72 seal structure
73 2K seal
74 end
75 PUR seal
76 O-ring seal
77 end
80 screw connection
84 snap-on element
85 snap-on element
86 snap-on element
87 snap-on element
88 snap-on element
89 snap-on element
90 snap-on element
91 snap-on element
92 snap-on element
93 snap-on element
100 filter system
102 inlet
104 outlet
110 filter housing
112 housing top part
114 housing bottom part
116 inner side
118 connection element
120 resonator structure at the housing
122 groove
124 groove
126 partition
128 connection openings
130 outlet
134 seal structure
136 annular groove
216 end face
220 resonator structure
222 groove
224 groove
226 partition
228 opening
230 interior
232 end disk
234 seal structure
236 support element
L longitudinal axis filter elements
M housing axis
N longitudinal axis secondary element

What is claimed is:

1. A filter system for filtering a fluid, the filter system comprising:
a filter housing comprising a housing top part and a housing bottom part, wherein the housing top part and the housing bottom part extend along a housing axis;
a filter pack configured to be arranged in the filter housing and configured to separate fluid-tightly a clean fluid side and a raw fluid side from each other in the filter housing;
wherein the filter pack comprises a filter element comprising a hollow cylinder-type filter bellows arranged about a longitudinal axis of the filter element;
wherein the filter element comprises a first end face and a first end disk arranged at the first end face, wherein the first end face is substantially closed;
wherein the filter element further comprises a second end disk arranged at a second end face, wherein the first end disk is positioned opposite the second end disk, and wherein the second end disk comprises a fluid passage for filtered fluid;
a resonator comprising an end closed by a bottom, wherein the resonator is arranged in an interior of the filter pack such that the bottom is oriented toward the first end disk of the filter element.

2. The filter system according to claim 1, further comprising a seal device, wherein the resonator and the filter pack adjoin each other through the seal device.

3. The filter system according to claim 2, wherein the first end disk of the filter element comprises an opening through which the resonator extends at least partially and is sealed relative to the opening of the first end disk.

4. The filter system according to claim 3, wherein the seal device is a seal structure disposed at the first end disk of the filter element, wherein the seal structure surrounds the opening of the first end disk and seals relative to the resonator.

5. The filter system according to claim 4, wherein the seal device is selected from the group consisting of a PUR seal, an O-ring seal, a 2K seal, and a labyrinth seal.

6. The filter system according to claim 1, wherein the filter pack comprises a central tube arranged in the interior of the filter pack, wherein the central tube comprises a bottom, and wherein the bottom of the resonator is integrated in the bottom of the central tube.

7. The filter system according to claim 6, wherein the resonator is connected by a snap-on connection to the central tube.

8. The filter system according to claim 6, wherein the central tube comprises an end positioned opposite the first end face of the filter element, wherein the resonator is connected to the end of the central tube.

9. The filter system according to claim 8, wherein the resonator is arranged to be exchangeable from the clean fluid side.

10. The filter system according to claim 6, wherein the filter pack further comprises a secondary element comprising a hollow cylinder-type filter bellows arranged about a longitudinal axis of the secondary element, wherein the secondary element is arranged inside the central tube of the filter element, wherein the resonator at least in sections is arranged in an interior of the secondary element such that the bottom of the resonator is oriented toward the first end disk of the filter element.

11. The filter system according to claim 10, wherein the secondary element is arranged concentrically to the housing axis of the filter housing and wherein the resonator is arranged concentrically to the longitudinal axis of the secondary element.

12. The filter system according to claim 10, wherein the secondary element comprises an end disk comprising an opening, wherein the resonator extends at least partially through the opening of the end disk of the secondary element, wherein the opening of the end disk of the secondary element seals relative to the resonator.

13. The filter system according to claim 12, wherein the end disk of the secondary element comprises a seal structure, wherein the seal structure surrounds the opening of the end disk of the secondary element and seals relative to the resonator.

14. The filter system according to claim 13, wherein the seal structure is selected from the group consisting of a 2K seal, a PUR seal, an O-ring seal, and a labyrinth seal.

15. The filter system according to claim 12, wherein the resonator is pushed in from an end face of the secondary element into the opening of the end disk of the secondary element.

16. The filter system according to claim 12, wherein the resonator is connected to the end disk of the secondary element by a snap-on connection.

17. The filter system according to claim 10, wherein the resonator is connected to a support structure of the secondary element.

18. The filter system according to claim 17, wherein the support structure of the secondary element comprises an end positioned opposite the first end face of the filter element, wherein the resonator is connected to the end of the support structure of the secondary element.

19. The filter system according to claim 1, wherein the resonator comprises an open end positioned opposite the bottom, wherein the open end is fastened in a region of the second end disk of the filter element.

20. A filter element for use in the filter system according to claim 1, the filter element comprising:
a hollow cylinder-type filter bellows arranged about a longitudinal axis of the filter element;
a first end face, wherein the first end face is substantially closed;
a first end disk arranged at the first end face;
a second end disk, wherein the first end disk is positioned opposite the second end disk;
wherein the second end disk comprises a fluid passage for filtered fluid.
